(19) United States
(12) Patent Application Publication
(10) Pub. No.: US 2012/0061932 A1
(43) Pub. Date: Mar. 15, 2012

(54) SCOOTER DECKS

(76) Inventor: Tom Floyd, Portland, OR (US)

(21) Appl. No.: 12/881,069

(22) Filed: Sep. 13, 2010

(51) Int. Cl. B62M 1/00; B23P 11/00; B21C 23/00

(52) U.S. Cl. 280/87.041; 72/254; 29/428

(57) ABSTRACT

A scooter deck includes elongate top and bottom deck plates having planar central longitudinal portions and side portions on either side thereof, with a pair of elongate stabilizing walls joining, and spacing, the central portions. The walls are disposed approximately one-third of the width of the top plate inward from the side edges thereof. The side portions of the top plate extend laterally from the central portion, whereas the side portions of the bottom plate incline upward toward, and meet, the side portions of the top deck plate, respectively, as they extend from the central portion of the bottom plate. The transverse cross-section of each side portion defines an S-curve. The scooter deck may has a constant transverse section along a majority of its length to define a multiple-tube configuration that offers substantial resistance to forces imparted during stunt riding.

### TECHNICAL FIELD

The disclosure relates to kick scooters, and in particular to scooter decks for kick scooters.

### BACKGROUND

Foot-powered scooters, also referred to as kick scooters, have enjoyed a resurgence in popularity in recent years, as a means of personal transport or recreational activity, generally for young children. As with skateboards, however, many users of scooters enjoy performing stunts or tricks with scooters, such as jumping one or more of the wheels of the scooter off the ground, sliding (riding the scooter while sliding the bottom along a structure such as a ledge or railing), and so forth. Many scooters, however, are not intended for such use, for example if the scooter components, such as the scooter deck, are not designed to endure the types of stress applied by trick riding.

For example, many scooters are designed simply to bear a certain amount of weight, such as by a rider who is riding the scooter with the wheels generally engaging the ground surface, and are correspondingly constructed to have a deck that includes a horizontal plate for the user to stand on, with a pair of spars or ribs to reinforce the plate against bending downward from bearing the rider's weight. The spars typically run longitudinally along the bottom surface of the plate, and are placed nearer to the side edges of the plate than to the center, to also provide support against the side edges being bent downward. In some designs, a bottom plate joins the bottom portions of the spars, such that this type of deck consists of a generally rectangular tube having short horizontal ridges of the top plate projecting outward to form the side edges.

As such, even though such a configuration may be suitable for bearing a rider's weight during simple riding, it typically does not provide support against the much stronger twisting forces and other impact forces due to stunts. Rider weight, for example, is typically greater for stunt riders than simple riders, considering that most stunt riders tend to be older children, teenagers, and even young adults, whereas simple riders tend to be younger children. Aside from differences in rider weight, however, even a simple stunt such as landing a jump delivers considerably more force to the portions of the deck bearing the rider's feet than simple riding, and also delivers a (typically upward) impact force to the wheel, or wheels, when they strike the surface, which may damage the wheel and/or its mounting structure, or bend the deck. Moreover, such forces are usually delivered quite suddenly. Other stunts, such as sliding a scooter along a structure (including landing the deck along such a structure to begin the slide), typically deliver an upward force to the bottom of the deck in contact with the structure, which acts as a fulcrum. Such a force may have a lateral component relative to the deck as well, for example if the bottom surface is not flat against the structure against which the deck is slid. Moreover, a twisting force may result if the rider's weight is unevenly distributed during a slide. More complex stunts may deliver a variety of twisting and bending forces to the scooter deck. Because the spars and/or bottom plate of most scooters are generally not intended to contact a ground surface when a user rides the scooter normally, such components are typically not designed to withstand or distribute such forces. Also, a single tube design may offer poor resistance to twisting forces.

### SUMMARY

Illustrative embodiments of a scooter deck, and illustrative methods of producing a scooter deck, are disclosed. A scooter deck according to this disclosure may offer substantial resistance to bending and twisting forces delivered thereto, for example as encountered during stunt scooter riding.

Illustrative embodiments of a scooter deck as shown and described herein includes elongate top and bottom deck plates that each further include a generally planar central longitudinal portion with side portions on either side, with the central portion of the top deck plate joined to, and spaced from, the central portion of the bottom deck plate by a pair of stabilizing walls extending longitudinally between the top and bottom deck plates. The side portions of the top deck plate extend generally laterally from the central portion, whereas the side portions of the bottom deck plate incline upward toward, and meet, the side portions of the top deck plate, respectively, as they extend from the central portion of the bottom deck plate.

In some embodiments, the side portions of the bottom deck plate include, as they extend from the central portion, a region extending laterally from the central portion, a region that inclines upward from the plane thereof, a region that extends outward from the upwardly-inclined region, and a region that meets the corresponding side portion of the top deck plate, forming a ridge. In such embodiments, the transverse cross-section of the side portion of the bottom deck plate may define an S-curve, with at least part of the upwardly-inclined region being perpendicular to the plane of the bottom deck plate. In such embodiments, the side portions of the top deck plate may angle slightly upward from the plane of the central portion thereof, such that the transverse cross-section of the top deck plate is slightly concave.

In some embodiments, the stabilizing walls may be disposed about one-third of the width of the top deck plate from the side edges, and may be perpendicular to the plane of central portion of the top deck plate. In some embodiments, the scooter deck may have a constant transverse cross-section along a majority of its length, such as that produced as a unitary body by an extrusion process. In such embodiments, the scooter deck may include an aperture formed in the front portion thereof, extending between the walls, such as to closely capture a head tube, and may additionally include an aperture formed in the rear portion thereof, extending between the walls, such as to receive a rear wheel and/or a rear wheel brake.

Illustrative embodiments of a scooter incorporating a scooter deck as shown and described herein may include, in addition to the scooter deck, a down tube having a bottom end mounted in an aperture in the front portion of the deck and a top end attached to a head tube, to which a handlebar assembly may in turn be pivotably mounted and a front wheel rotatably coupled, with a rear wheel rotatably coupled to the rear portion of the deck.

Illustrative methods of producing a scooter deck as shown and described herein may include a first step of producing an elongate, unitary scooter deck piece with an extrusion tool adapted to form an extruded cross-section having a central, closed, quadrilateral cavity defined by horizontal top and bottom walls and two side walls, and two closed side cavities on either side of the central cavity that are each bounded by a side wall, a top wall that extends away from the side wall, and a bottom wall that includes at least one upwardly inclined region. Such methods may then include additional steps of forming a down tube aperture in the front portion of the extruded deck piece through the top wall of the central cavity and into the central cavity between the side walls thereof, and forming a rear wheel aperture in the rear portion of the extruded deck piece through the top and bottom walls of the central cavity and into the central cavity between the side walls thereof. Such methods may also include removing a portion of the upwardly inclined regions of the bottom wall in the rear portion of the extruded deck piece to thereby expose and provide access to, from the sides of the scooter deck piece, portions of the side walls defining the central cavity, and forming bores in the exposed portions of the side walls to provide a rear wheel mount. Optionally, methods of assembling a scooter may include, closely capturing a down tube in the down tube aperture by means of the side walls of the central cavity, and mounting the down tube in the down tube aperture.

### BRIEF DESCRIPTION OF THE DRAWINGS

FIG. 1 shows a side view of a scooter having a scooter deck constructed in accordance with the present disclosure.

FIG. 2 shows a cross-sectional view, taken along the line 2-2, of the scooter deck of FIG. 1.

FIG. 3 shows a side view of the scooter deck of FIG. 1.

FIG. 4 shows a top plan view of the scooter deck of FIG. 1.

FIG. 5 shows a bottom view of the scooter deck of FIG. 1.

### DETAILED DESCRIPTION

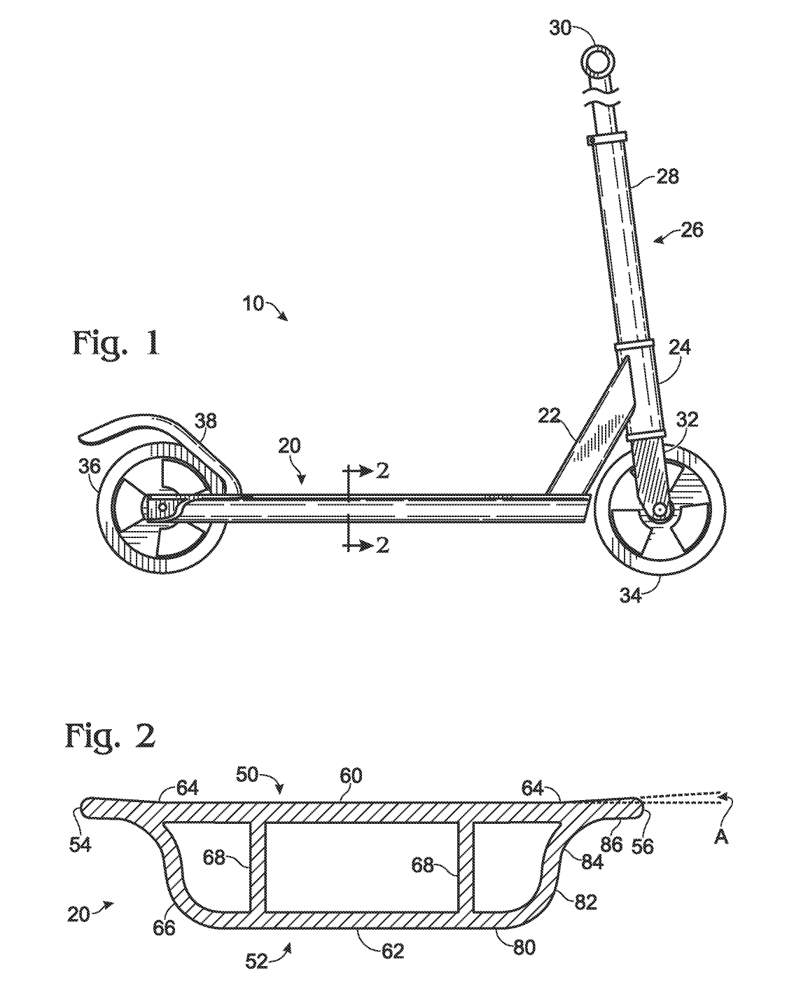

The drawings show an illustrative and non-limiting embodiment of a scooter having a scooter deck constructed in accordance with aspects of the invention as set forth in the claims. More specifically, FIG. 1 shows a scooter, generally designated at 10. Scooter 10 is shown to include a scooter deck 20, from which a down tube 22 extends generally upwardly, and forwardly, from a front section thereof. As discussed below, the down tube is positioned and secured within an aperture formed through the scooter deck. A head tube 24 is shown to be attached to the top end of the down tube, and is configured to accommodate a suitable handlebar assembly and front wheel. In the illustrated embodiment, for example, handlebar assembly 26 is shown to be pivotably mounted to the head tube, such as by means of a fork tube 28, which extends through the head tube. As shown, fork tube 28 terminates at its upper end with a pair of handlebars 30, and supports at its lower end a fork 32 to which a front wheel 34 is rotatably coupled. The rear section of the scooter deck is configured to accommodate a suitable rear wheel and/or brake system, such as rear wheel 36, which is shown to be rotatably coupled to a rear section of the scooter deck 20. Although not required to all embodiments, the illustrated embodiment features a fender brake 38 pivotably mounted to the rear section of the scooter deck proximate to the rear wheel.

Scooter deck 20 is thus supported relative to a ground surface by the front and rear wheels, although alternative embodiments may include more than two wheels supporting the scooter deck. In use, a user may ride scooter 10 in a standing position, with one foot placed on the top surface of the deck, using the other to kick against the ground to provide a motive force to the scooter. The scooter may be steered via the handlebars 30, and the fender brake 38, which is typically biased toward a non-engaged position relative to the rear wheel, may be controlled by pressing it downward, such as by one of the user's feet, to urge the brake into contact with the rear wheel. Alternative embodiments may include brakes or braking systems other than as shown, or no braking system.

The scooter deck of the illustrated embodiment is shown in more detail in FIGS. 2-5, which show the deck to be formed of elongate top and bottom deck plates 50, 52 that are joined together at common longitudinal edges 54, 56, but are spaced apart at central portions thereof. The scooter deck is shown to have bilateral symmetry, with each longitudinal half a mirror image of the other.

FIG. 2 shows that top and bottom deck plates 50, 52 each include a generally planar central longitudinal portion 60, 62 and side portions 64, 66 on either side thereof. The central portions are shown to be joined together, and spaced apart from each other, by means of a pair of stabilizing walls 68 that extend longitudinally between the deck plates. The side portions 64 of the top plate 50 are shown in the illustrated embodiment extend generally laterally from the central portion 60 thereof. The side portions 66 of the bottom plate 52, however, incline upward to meet the side portions 64 of the top deck 50 plate as they extend from the central portion 62 of the bottom plate.

As such, the illustrated scooter deck cross-section can be thought of as including three cavities: a central, closed, quadrilateral cavity defined by the central portions 60, 62 of the top and bottom deck plates and the two stabilizing walls 68, and two closed side cavities on either wise of the central cavity that are each bounded by a stabilizing wall 68, a side portion 64 of the top deck plate 50, and a side portion 66 of the bottom deck plate 52.

Although not required to all embodiments, as can be seen most clearly in FIGS. 4 and 5, the scooter deck of the illustrated embodiment has a constant transverse cross-section along a majority of its length; as explained in detail below, the scooter deck of the illustrated embodiment may be produced by an extrusion process. As such, the scooter deck as illustrated may be thought of as including three parallel “tubes” corresponding to the three cavities of the cross-section.

Together, the stabilizing walls and the side portions of the bottom plate (or, in other words, the “multiple-tube” configuration of the illustrated embodiment) provide resistance both to bending forces and to twisting forces applied to the deck, such as those due to various stunts a user may perform (i.e., sliding, jumping, and so forth) by distributing and absorbing such forces throughout the structural components thereof.

For example, although not required to all embodiments, the walls 68 of the scooter deck 20 shown in the illustrated embodiment are shown to be separated by a distance of approximately one-third of the width of the top deck plate 50; in other words, the walls 68 are placed approximately one-third of the width of the top deck plate 50 from either edge 54, 56 thereof. In a more specific example, in a commercial embodiment, the width of the top deck plate is 4.50 inches, and the walls are disposed so that the facing surfaces thereof are separated by a distance of 1.54 inches. Because the side portions 66 of the bottom deck plate 52 join with, and thereby provide support to, the edges of the top deck plate, the positioning of the walls 68 at approximately one-third of the width of the top deck plate 50 from each edge may result in a more even distribution of downward force applied to the top deck plate than one in which the walls are positioned further toward the edges, or closer to each other.

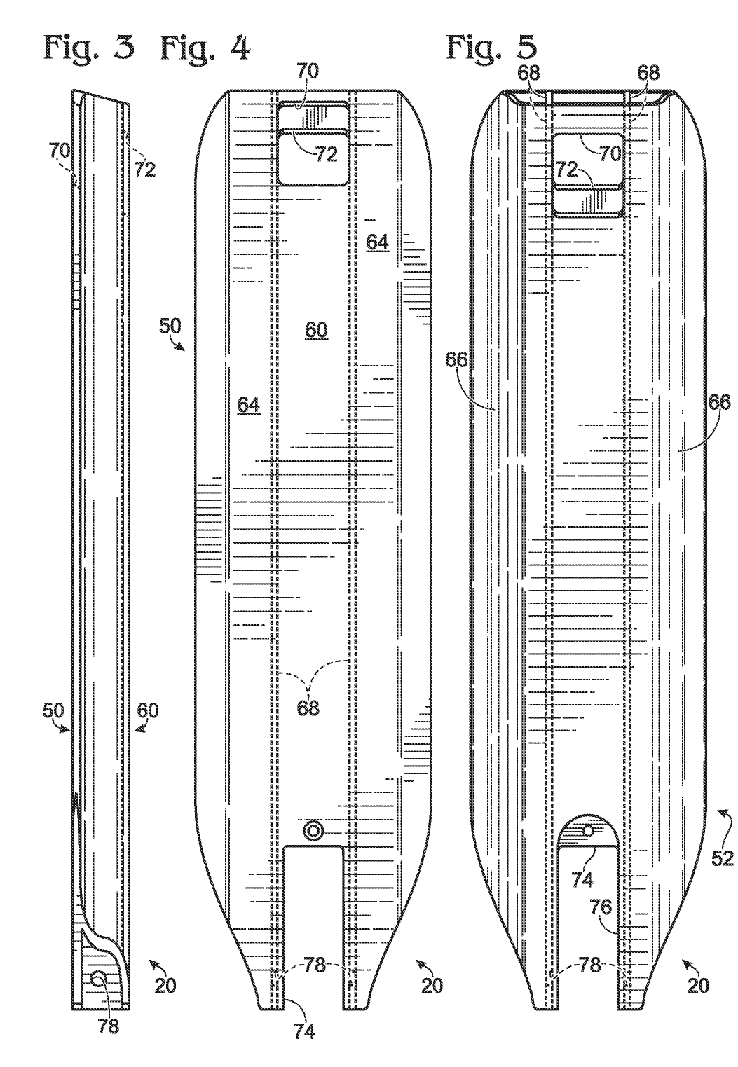

Additionally, the walls 68 may also provide support to the down tube 22, as follows. As shown in FIGS. 3-5, an aperture for the down tube is formed in the scooter deck, consisting of a pair of openings 70, 72 near the front edges of the central portions of the top and bottom deck plates. The openings are shown to be generally square-shaped to receive a down tube having a matching cross-section, but of course may be of any shape appropriate to the configuration of the down tube used. Also, the openings are longitudinally offset from each other to provide a desired angle to the down tube as it extends upward from the scooter deck. For example, in the commercial embodiment mentioned above, the angle of the down tube as it extends from the scooter deck is approximately 60 degrees from the plane of the top deck plate. Moreover, the openings 70, 72 are disposed so that the aperture for the down tube extends between the walls 68; that is, when the down tube is positioned in the down tube aperture, the walls 68 are adjacent the down tube. For example, in the commercial embodiment, the openings 70, 72 are 1.50 inches wide to receive a down tube of the same width; thus, the walls 68 closely capture, and are parallel to, the outer walls of the down tube 22, being spaced therefrom in the commercial embodiment by approximately 0.02 inches. As such, the walls 68 may provide greater support and stability to the down tube 22 when the scooter is in use, such as by reinforcing the orientation and position of the down tube relative to the scooter deck against twisting forces and/or compressive or tensile forces administered thereto, such as may be encountered during stunts performed by a user, than walls that do not closely capture the down tube. Moreover, as explained below, the walls 68 may also provide support when the scooter is fabricated, such as when the down tube 22 is welded or otherwise secured to the scooter deck.

The walls 68 may also provide support to the rear wheel 36, as follows. As shown in FIGS. 3-5, a rear wheel aperture is formed in the scooter deck, consisting of a pair of openings 74, 76 near the edge of the central portions of the top and bottom deck plates. The openings are shown to be open; that is, the openings take the form of generally U-shaped notches that extend forwardly into the deck plates 50, 52 from the rear edges thereof. Similar to openings 70, 72 that form the aperture for the down tube 22, openings 74, 76 extend into the central portions 60, 62 of top and bottom plates between the walls 68; as such, the openings are sized to receive a rear wheel, such as rear wheel 36, and/or a brake assembly for the rear wheel, such as fender brake 38, mounted between the walls.

Such a rear wheel may be rotatably mounted in any suitable manner, such as on an axle member, such as an axle bolt (not shown), that is supported by and between the walls 68, for example in a configuration in which the axle member is journaled or otherwise mounted in appropriately sized bores formed in the walls. Walls 68 in the illustrated embodiment are shown to include bores 78 adapted to accommodate such a rear wheel mount. In general, the shorter the span of the axle member between its supports, the less prone it is to bending along its length, such as due to impact to the wheel supported thereon, for example when a user lands a jump on the wheels of the scooter. As such, similar to openings 70, 72 that form the aperture for the down tube 22, the walls 68 may provide greater support and stability to the rear wheel 36, and/or the axle or other mounting components thereof, due to the proximity of the walls to the wheel and to each other, as compared with support provided by walls that are positioned further away.

A fender brake, such as fender brake 38, may also be mounted in any suitable manner. In the illustrated embodiment, the fender brake may be mounted to the scooter deck proximate the opening 74, such as by securing suitable mounting structure to the bottom surface of the top plate. Embodiments of such a fender brake assembly are disclosed in the applicant's co-pending U.S. patent application Fender Brake Assemblies for Scooters, Ser. No. ______, filed on ______, the entire disclosure of which is herein incorporated by reference. The opening 76 in the bottom deck plate 52 is shown to extends further toward the front portion of the scooter deck than the opening 74 in the top deck plate 50; the shelf-like projection that is thereby produced by the portion of the top plate above the opening 76 may thus allow access to the mounting structure, for example for repair or replacement, while at the same time protecting such components from damage from impacts delivered to the bottom deck plate.

As noted above, although not required to all embodiments, the scooter deck of the illustrated embodiment is shown to be slightly rounded near the front edge thereof, and tapered near the rear edge, generally in the area of the openings 70, 72. More particularly, the width of the top and bottom deck plates, which is shown to be constant along most of the length of the scooter deck, narrows gradually from a point on the edges 54, 56 that is approximately equidistant from the rear edge of the scooter deck to the forward edge of the opening 70, to the rear edge, such that at its rear edge, the width of the top deck plate is only slightly wider than the distance between walls 68. Although shown in the illustrated as describing a generally curved taper, the contouring may in alternative embodiments describe a linear taper, or have a different configuration. The contouring may allow easier operation of the fender brake, for example because a user may be able to easily determine the position of the fender brake relative to the edge of the scooter deck “by feel,” such as with the user's foot, when encountering the contoured edge. Also, as shown in FIGS. 3-5, the contouring allows the portion of the walls 68 in which bores 78 are formed to be exposed and thereby accessed from the sides of the scooter deck, for example if necessary to perform maintenance to the rear wheel and/or its mounting components, while at the same time providing a surrounding wall in which the end of the axle member, or other mounting structure, is recessed, which may protect such components from damage from impact to that portion of the scooter deck.

Although not required to all embodiments, the stabilizing walls 68 of the illustrated embodiment are shown to be substantially continuous along their lengths (with the exception of bores 78), extending along the entire lengths of the top and bottom deck plates, having a consistent cross-section along their lengths, and generally bearing the same positional relationship with the top and bottom deck plates throughout the length of the scooter deck, characteristics that the skilled artisan will recognize are consistent with a profile formed by an extrusion process. Also, the stabilizing walls 68 are shown to be parallel to each other, perpendicular to the central portions of the top and bottom deck plates they connect, and having a thickness consistent with that of the top and bottom deck plates.

In alternative embodiments, however, the stabilizing walls may take other configurations as suitable to accomplish the functions and features as discussed above, such as being discontinuous or even intermittent along their lengths, adopting a zig-zag, curved, or other configuration(s), inclining toward or away from each other vertically and/or longitudinally, and so forth, or may include multiple configurations along their lengths; such configurations may be constant along the length of the scooter deck and thus may be produced by an appropriate extrusion die, or may have a non-constant cross-section, such as produced by other fabrication techniques. Moreover, although one pair of stabilizing walls is shown, alternative embodiments may include additional walls or interior stabilizing structure. For example, alternative embodiments may include two pairs of walls running along one or more portions of the scooter deck, spars or other bracing components extending between the walls, and so forth. Such variations are considered to be within the scope of this disclosure.

Returning to FIG. 2, each side portion 64 of the top deck plate 50 of the illustrated embodiment is shown to incline slightly upward from the plane of the central portion 60, such that the cross-sectional shape of the top deck plate describes a shallow concavity. The angle of inclination from the plane of the central portion 60 is represented in FIG. 2 at A; in the commercial embodiment, angle A is approximately 3 degrees. The inclined side portions 64 may serve to allow the rider to more easily feel the lateral position of his or her feet on the top deck plate 50, as compared with a completely flat deck plate, by providing more tactile references than only the side edges 54, 56. Correspondingly, the inclined side portions may allow a rider greater traction as compared with a flat deck plate, and may also afford a greater amount of control over leaning the scooter to one side or the other, by effectively reducing the amount of downward travel the rider must move a foot to the side of the deck plate before applying downward leaning force. Being inclined slightly upward, the side portions 64 also may more easily resist bending downward than horizontally projecting side portions.

Still referring to FIG. 2, each side portion 66 of the bottom deck plate 52 may be thought of as consisting of several longitudinal regions as it extends from the central portion 62, and thus the overall shape described by the side portions 66 may be described in terms of these longitudinal regions. Although not required to all embodiments, each side portion 66 of the illustrated embodiment is shown to include a first region 80 that extends generally laterally from the central portion 62, a second region 82 that inclines upward from the plane of the central portion 62 (and the first region 80), a third region 84 that extends outward from the second region 82, and a fourth region 86 that meets the corresponding side portion 64 of the top plate 50 to form a ridge at the common outer edges 54, 56. Even more specifically, the illustrated embodiment is shown to be curved where the regions of the side portion 64 meet each other, such that the transverse cross-section thereof defines a continuous S-curve, with the top and bottom parts of the “S” approaching a plane generally parallel with that of the central portion 62 of the bottom plate 52, and the middle part approaching a plane generally perpendicular to that of the central portion 62 of the bottom plate 52. The curved nature of the side portions of the bottom deck plate, in combination with the smooth, continuous surface of the deck plate itself, may facilitate sliding stunts by providing an edge-free surface to slide along various structures, which may in turn allow a rider to easily change the orientation of the deck relative to the structure upon which it is slid. Additionally, the curved side portions 66 may provide greater structural resistance to bending and twisting forces than a side portion having a simple linear (i.e. diagonal) cross-sectional shape. Moreover, users may find the rounded nature of the side portions to be more finger-friendly than square edges, such as when executing stunts in which one or both edges 54, 56 of the deck is grabbed. Also, the ridge formed where the side portions 66 of the bottom plate 52 that incline upward to meet the side portions 64 of the top plate 50 provides significantly more vertical clearance from the ground than would be provided by simply grabbing the bottom surface of the deck, reducing the chance of a rider's fingers contacting the ground when the ridge is gripped.

The cross-sectional shape of the side portions 66 of the bottom plate 52 may, however, take other configurations than as shown. For example, the side portions of alternative embodiments may describe shallower or deeper S-curves (in other words, S-curves having curves of greater or smaller radii, respectively), or differently-shaped curves, or may consist of multiple linear regions instead of curved regions, or a compound shape consisting of linear and curved regions. Moreover, consistent with a shape produced by an extrusion process, the illustrated scooter deck has a constant cross-section along its length, but alternative embodiments, such as may be produced by other fabrication methods and/or multiple extrusion profiles, may feature non-constant cross-sections. For example, an alternative embodiment may include the cross-section shown in FIG. 2 for only a portion of its length, with the side portions morphing into a different configuration (or configurations) along other portions. One example of such an alternative embodiment may be a scooter deck having side portions with the S-curve cross-section shown in FIG. 2 through a central, middle length of the scooter deck, for example where a user may typically reach to grab the edge of the deck to do a stunt, but the side portions may have a different cross-sectional shape in the front and/or rear portions of the deck.

As noted above, the scooter deck of the illustrated embodiment may be produced by a fabrication method that includes extruding the scooter deck as a unitary component. More particularly, an example method of producing the scooter deck of the illustrated embodiment may use an extrustion tool adapted to form an extruded cross-section as shown, for example, in FIG. 2; that is, a cross-section having a central, closed, quadrilateral cavity defined by horizontal top and bottom walls (such as the central portions 60, 62 of the top and bottom deck plates 50, 52) and two side walls (such as walls 68), and two closed side cavities on either side thereof that are each bounded by a side wall (such as walls 68) a top wall that extends away from the side wall (such as side portions 64), and a bottom wall (such as side portions 66) that includes at least one upwardly inclined region (such as second region 82). A first step of such a method may be producing, using such an extrusion tool, an elongate, unitary scooter deck piece having front and rear portions. The example method may then include forming a down tube aperture (such as opening 70) in the front portion of the extruded deck piece through the top wall of the central cavity, and into the central cavity between the side walls, and forming a rear wheel aperture (such as openings 74, 76) in the rear portion of the extruded deck piece through the top and bottom walls of the central cavity and into the central cavity between the side walls. The method may also include removing a portion of the upwardly inclined regions of the bottom wall in the rear portion of the extruded deck piece to expose and provide access to, from the sides of the scooter deck piece, portions of the side walls, and forming bores in the exposed portions of the side walls to provide a rear wheel mount.

At this point, the scooter deck may be ready for additional assembly procedures, such as mounting the down tube, head tube, and/or other components thereto, or may instead be sanded, contoured, painted, and/or otherwise undergo finishing treatments, prior to further assembly procedures. For example, an assembly method may include additional fabrication steps, such as mounting a down tube, such as down tube 22, in the down tube aperture, securing the down tube at its bottom end to the bottom wall (such as the central portion of the bottom deck plate 52), and securing the portion of the down tube the projects through the top wall (e.g., through opening 70) to the top wall (e.g., the central portion of the top deck plate 50, in which the opening is formed). Securing may be performed by any suitable technique, such as welding. As noted above, the configuration of the side walls 68 may closely capture, and thereby stabilize, the down tube, preventing twisting or otherwise limiting movement of the down tube during the welding process. A head tube, such as head tube 24, may be secured to the upper end of the down tube, such as by welding. The down tube 22 and/or head tube 24 themselves may optionally be produced by an extrusion process, using suitable extrusion tools, or any appropriate method.

Although the present invention has been shown and described with reference to the foregoing operational principles and illustrated examples and embodiments, it will be apparent to those skilled in the art that various changes in form and detail may be made without departing from the spirit and scope of the invention. The present invention is intended to embrace all such alternatives, modifications and variances that fall within the scope of the appended claims.

I claim:

1. A scooter deck comprising elongate top and bottom deck plates that each include a generally planar central longitudinal portion and side portions on either side thereof, wherein the central portion of the top deck plate is joined to, and spaced from, the central portion of the bottom deck plate by means of a pair of stabilizing walls extending longitudinally between the top and bottom deck plates, wherein the side portions of the top deck plate extend generally laterally from the central portion, and wherein the side portions of the bottom deck plate incline upward toward, and meet, the side portions of the top deck plate, respectively, as they extend from the central portion of the bottom deck plate.

2. The scooter deck of claim 1, wherein each side portion of the bottom deck plate includes, as it extends from the central portion thereof to meet the side portion of the top deck plate, a first region that extends generally laterally from the central portion, a second region that inclines upward from the plane of the central portion, a third region that extends outward from the second region, and a fourth region that meets the corresponding side portion of the top deck plate, to thereby form a ridge.

3. The scooter deck of claim 2, wherein the side portions of the bottom deck plate are curved where the regions thereof meet, such that a transverse cross-section of each said side portion defines an S-curve.

4. The scooter deck of claim 2, wherein the fourth region and the corresponding side portion of the top deck plate share a common outer edge.

5. The scooter deck of claim 2, wherein at least a part of the second region is perpendicular to the plane of the central portion of the bottom deck plate.

6. The scooter deck of claim 1, wherein the side portions of the top deck plate incline upward from the plane of the central portion thereof near the outer edges of the side portions, such that a transverse cross-section of the top deck plate is slightly concave.

7. The scooter deck of claim 6, wherein the side portions of the top deck plate angle upward from the plane of the central portion thereof by approximately 3 degrees.

8. The scooter deck of claim 1, wherein the walls are disposed equidistantly from the longitudinal central axis of the top deck plate.

9. The scooter deck of claim 8, wherein the top deck plate has a width, and wherein the distance between the walls is approximately one-third of the width of the widest point of the top deck plate.

10. The scooter deck of claim 8, wherein the walls are perpendicular to the plane of the central portion of the top deck plate.

11. The scooter deck of claim 8, wherein the walls are parallel to each other.

12. The scooter deck of claim 1, wherein the deck has a constant transverse cross-section along a majority of its length.

13. The scooter deck of claim 1, wherein a rear end portion thereof includes a rear wheel aperture formed by openings in the central portions of the top and bottom deck plates and extending through the scooter deck between the walls thereof.

14. The scooter deck of claim 13, wherein the side portions of the bottom deck plate on either side of the rear wheel aperture include openings formed therein adapted to expose, and thereby provide access to, at least a portion of the walls.

15. The scooter deck of claim 14, wherein the exposed portions of the walls include bores formed therethrough, the bores being adapted to provide a rear wheel mount.

16. A scooter, comprising:
a deck, the deck further comprising elongate top and bottom deck plates that each include a central longitudinal portion and side portions on either side thereof, wherein the central portion of the top deck plate is joined to, and spaced from, the central portion of the bottom deck plate by means of a pair of stabilizing walls extending longitudinally between the top and bottom deck plates, and wherein the side portions of the bottom deck plate incline toward and meet the side portions of the top deck plate, respectively, as they extend from the central portion of the bottom deck plate;
a down tube having a bottom end and a top end, the bottom end extending generally upward from the central portion of the bottom deck plate and through the central portion of the top deck plate near a forward edge of the deck;
a head tube attached to the top end of the down tube,
a handlebar assembly pivotably mounted to the head tube;
a front wheel rotatably coupled to the head tube; and
a rear wheel rotatably coupled to a rear portion of the deck.

17. A method of producing a scooter deck, the method comprising:
producing, with an extrusion tool adapted to form an extruded cross-section having a central, closed, quadrilateral cavity defined by horizontal top and bottom walls and two side walls, and two closed side cavities on either side of the central cavity that are each bounded by a side wall, a top wall that extends away from the side wall, and a bottom wall that includes at least one upwardly inclined region, an elongate, unitary scooter deck piece having front and rear portions;
forming a down tube aperture in the front portion of the extruded deck piece through the top wall of the central cavity and into the central cavity between the side walls thereof;
forming a rear wheel aperture in the rear portion of the extruded deck piece through the top and bottom walls of the central cavity and into the central cavity between the side walls thereof;
removing at least a portion of the upwardly inclined regions of the bottom wall in the rear portion of the extruded deck piece to thereby expose and provide access to, from the sides of the scooter deck piece, portions of the side walls defining the central cavity;
forming bores in the exposed portions of the side walls that are adapted to provide a rear wheel mount.

18. The method of claim 17, wherein forming a rear wheel aperture further includes forming an aperture in the bottom wall that extends further toward the front portion of the deck piece than the aperture in the top wall.

19. The method of claim 17, further including, after forming a down tube aperture, closely capturing a down tube in the down tube aperture by means of the side walls of the central cavity, and mounting a down tube in the down tube aperture.

20. The method of claim 19, wherein mounting a down tube further includes securing the down tube at its bottom end to the bottom wall, and securing the portion of the down tube that protrudes through the top wall to the top wall.
